(19) United States
(12) Patent Application Publication
(10) Pub. No.: US 2011/0125789 A1
(43) Pub. Date: May 26, 2011

(54) METHOD AND APPARATUS FOR REPRESENTING SENSORY EFFECTS AND COMPUTER READABLE RECORDING MEDIUM STORING SENSORY DEVICE COMMAND METADATA

(76) Inventors: Sanghyun Joo, Daejon (KR); Bum-Suk Choi, Daejon (KR); Seungsoon Park, Seoul (KR); Hae-Ryong Lee, Daejon (KR); Kwang-Roh Park, Daejon (KR)

(21) Appl. No.: 13/054,679

(22) PCT Filed: Jul. 16, 2009
(86) PCT No.: PCT/KR2009/003946

§ 371 Date: Jan. 18, 2011

Related U.S. Application Data
(60) Provisional application No. 61/081,366, filed on Jul. 16, 2008.

(51) Int. Cl. G06F 17/30

(52) U.S. Cl. 707/769; 707/E17.014

(57) ABSTRACT

Provided are method and apparatus for representing sensory effects, and a computer readable recording medium storing sensory device command metadata. A method for representing sensory effects, includes: receiving sensory effect metadata including sensory effect information; obtaining the sensory effect information by analyzing the sensory effect metadata; and generating sensory device command metadata for controlling sensory devices corresponding to the sensory effect information, wherein the sensory device command metadata includes sensory device command description information for controlling the sensory devices.

### TECHNICAL FIELD

The present invention relates to a method and apparatus for representing sensory effects, and a computer readable recording medium storing sensory device command metadata.

### BACKGROUND ART

In general, media includes audio and video. The audio may be voice or sound and the video may be a still image and a moving image. When a user consumes or reproduces media, a user uses metadata to obtain information about media. Here, the metadata is data about media. Meanwhile, a device for reproducing media has been advanced from devices reproducing media recorded in an analog format to devices reproducing media recorded in a digital format.

An audio output device such as speakers and a video output device such as a display device have been used to reproduce media.

FIG. 1 is a diagram for schematically describing a media technology according to the related art. As shown in FIG. 1, media is outputted to a user using a media reproducing device 104. The media reproducing device 104 according to the related art include only devices for outputting audio and video. Such a conventional service is referred as a single media single device (SMSD) based service in which one media is reproduced through one device.

Meanwhile, audio and video technologies have been advanced to effectively provide media to a user. For example, an audio technology has been developed to process an audio signal to a multi-channel signal or a multi-object signal or a display technology also has been advanced to process video to a high quality video, a stereoscopic video, and a three dimensional image.

Related to a media technology, a moving picture experts group (MPEG) has introduced MPEG-1, MPEG-2, MPEG-4, MPEG-7, and MPEG-21 and has developed new media concept and multimedia processing technology. MPEG-1 defines a formation for storing audio and video and MPEG-2 defines specification about audio transmission. MPEG-4 defines an object-based media structure. MPEG-7 defines specification about metadata related to media, and MPEG-21 defines media distribution framework technology.

Although realistic experiences can be provided to a user through 3-D audio/video devices due to the development of the media technology, it is very difficult to realize sensory effects only with audio/video devices and media.

### DISCLOSURE

### Technical Problem

An embodiment of the present invention is directed to providing a method and apparatus for representing sensory effects in order to maximize media reproducing effects by realizing sensory effects when media is reproduced.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for representing sensory effects, comprising: receiving sensory effect metadata including sensory effect information; obtaining the sensory effect information by analyzing the sensory effect metadata; and generating sensory device command metadata for controlling sensory devices corresponding to the sensory effect information, wherein the sensory device command metadata includes sensory device command description information for controlling the sensory devices.

In accordance with another aspect of the present invention, there is provided an apparatus for representing sensory effects, comprising: an input unit configured to receive sensory effect metadata including sensory effect information about sensory effects applied to media; and a control unit configured to obtain the sensory effect information by analyzing the sensory effect metadata and generate sensory device command metadata for controlling sensory devices corresponding to the sensory effect information, wherein the sensory device control metadata includes sensory device command description information for controlling the sensory device.

In accordance with another aspect of the present invention, there is provided a method for realizing sensory effects, comprising: receiving sensory device command metadata for realizing sensory effects applied to media from an apparatus for representing sensory effects; and realizing the sensory effects using the sensory device command metadata, wherein the sensory device command metadata includes sensory device command description information for controlling the sensory devices.

In accordance with another aspect of the present invention, there is provided an apparatus for realizing sensory effects, comprising: an input unit configured to receive sensory device command metadata for realizing sensory effects applied to media from an apparatus for representing sensory effects; and a controlling unit configured to realize the sensory effects using the sensory device command metadata, wherein the sensory device command metadata includes sensory device command description information for controlling the sensory devices.

In accordance with another aspect of the present invention, there is provided a computer readable recording medium storing metadata, wherein the metadata comprising: Sensory device command metadata for controlling sensory devices corresponding sensory effect information, wherein the sensory device command metadata includes sensory device command description information for controlling the sensory devices.

### Advantageous Effects

A method and apparatus for reproducing sensory effects can maximize media reproducing effects by realizing sensory effects when media is reproduced.

### BRIEF DESCRIPTION OF THE DRAWINGS

FIG. 1 is a schematic diagram illustrating a media technology according to the related art.

FIG. 2 is a conceptual diagram illustrating realizing sensor effect media in accordance with an embodiment of the present invention.

FIG. 3 is a diagram illustrating a single media multiple device (SMMD) system for representing sensory effects in accordance with an embodiment of the present invention.

FIG. 4 is a diagram illustrating a sensory media generator in accordance with an embodiment of the present invention.

FIG. 5 is a block diagram illustrating an apparatus for representing sensory effects in accordance with an embodiment of the present invention.

FIG. 6 is block diagram illustrating an apparatus for providing sensory device capability information in accordance with an embodiment of the present invention.

FIG. 7 is a block diagram illustrating an apparatus for providing user sensory preference information in accordance with an embodiment of the present invention.

FIG. 8 is a diagram illustrating sensory device command metadata in accordance with an embodiment of the present invention.

FIG. 9 is a diagram illustrating device command information (DeviceCommand) included in sensory device command metadata in accordance with an embodiment of the present invention.

FIG. 10 is a diagram illustrating a method for measuring a direction and a position of a sensory device in accordance with an embodiment of the present invention.

FIG. 11 is a diagram illustrating a common device command (DeviceCmdCommon) included in sensory device command metadata in accordance with an embodiment of the present invention.

FIG. 12 is a diagram illustrating an element SetPosition included in sensory device command metadata in accordance with an embodiment of the present invention.

FIG. 13 is a diagram illustrating an element SetDirection included in sensory device command metadata in accordance with an embodiment of the present invention.

FIG. 14 is a diagram illustrating a device specific command (DeviceCmdSpecific) included in sensory device command metadata in accordance with an embodiment of the present invention.

FIG. 15 is a diagram illustrating a light device control command (LightCmd) included in sensory device command metadata in accordance with an embodiment of the present invention.

FIG. 16 is a diagram illustrating a fan control command (FanCmd) included in sensory device command metadata in accordance with an embodiment of the present invention.

FIG. 17 is a diagram illustrating a temperature device control command (TemperatureCmd) included in sensory device command metadata in accordance with an embodiment of the present invention.

FIG. 18 is a diagram illustrating a vibration device control command (VibrationCmd) included in sensory device command metadata in accordance with an embodiment of the present invention.

FIG. 19 is a diagram illustrating a diffusion device control command (DiffusionCmd) included in sensory device command metadata in accordance with an embodiment of the present invention.

FIG. 20 is a diagram illustrating a shad device control command (ShadingCmd) included in sensory device command metadata in accordance with an embodiment of the present invention.

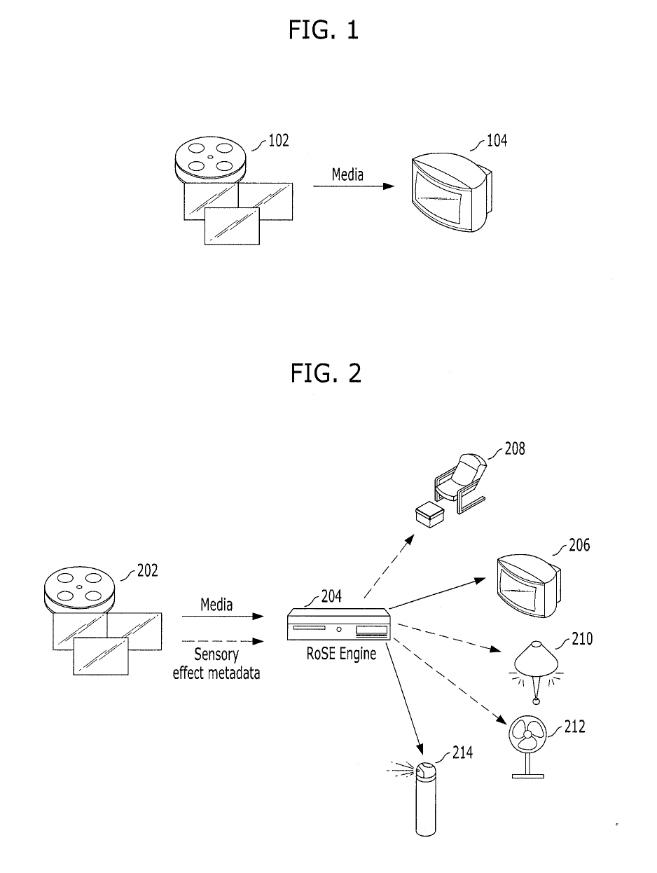

### BEST MODE FOR THE INVENTION

The advantages, features and aspects of the invention will become apparent from the following description of the embodiments with reference to the accompanying drawings, which is set forth hereinafter. In addition, if further detailed description on the related prior arts is determined to obscure the point of the present invention, the description is omitted. Hereafter, preferred embodiments of the present invention will be described in detail with reference to the drawings. The same reference numeral is given to the same element, although the element appears in different drawings.

Conventionally, audio and video are only objects of media generation and consumption such as reproducing. However, human has not only visual and auditory senses but also olfactory and tactile senses. Lately, many studies have been made to develop a device stimulating all of the five senses of human.

Meanwhile, home appliances controlled by an analog signal have been advanced to home appliances controlled by a digital signal.

Media has been limited as audio and video only. The concept of media limited as audio and video may be expanded by controlling devices that stimulate other senses such as olfactory or tactile sense with media incorporated. That is, a media service has been a single media single device (SMSD) based service in which one media is reproduced by one device. However, in order to maximize media reproducing effect in ubiquitous home, a single media multi devices (SMMD) based service may be realized. The SMMD based service reproduces one media through multiple devices.

Therefore, it is necessary to advance a media technology for reproducing media to simply watch and listen to a sensory effect type media technology for representing sensory effects with media reproduced in order to satisfy five senses of human. Such a sensory effect type media may extend a media industry and a market of sensory effect devices and provide rich experience to a user by maximizing media reproducing effect. Therefore, a sensory effect type media may promote the consumption of media.

FIG. 2 is a diagram illustrating realization of sensory effect media in accordance with an embodiment of the present invention.

Referring to FIG. 2, media 202 and sensory effect metadata are input to an apparatus for representing sensory effects. Here, the apparatus for representing sensory effects is also referred as a representation of sensory effect engine (RoSE Engine) 204. Here, the media 202 and the sensory effect metadata may be input to the representation of sensory effect engine (RoSE Engine) 204 by independent providers. For example, a media provider (not shown) may provide media 202 and a sensory effect provider (not shown) may provide the sensory effects metadata.

The media 202 includes audio and video, and the sensory effect metadata includes sensory effect information for representing or realizing sensory effects of media 202. The sensory effect metadata may include all information for maximizing reproducing effects of media 202. FIG. 2 exemplary shows visual sense, olfactory sense, and tactile sense as sensory effects. Therefore, sensory effect information includes visual sense effect information, olfactory sense effect information, and tactile sense effect information.

The RoSE engine 204 receives media 202 and controls a media output device 206 to reproduce the media 202. The RoSE engine 204 controls sensory effect devices 208, 210, 212, and 214 using visual effect information, olfactory effect information, and tactile effect information included in sensory effect metadata. Particularly, the RoSE engine 204 controls lights 210 using the visual effect information, controls a scent device 214 using the olfactory effect information, and controls a trembling chair 208 and a fan 212 using the tactile effect information.

For example, when video including a scene of lightning or thunder is reproduced, lights 210 are controlled to be turned on and off. When video including a scene of foods or a field is reproduced, the scent device 214 is controlled. Further, when video including a scene of water rafting or car chasing is reproduced, the trembling chair 208 and the fan 212 are controlled. Accordingly, sensory effects can be realized corresponding to scenes of video while reproducing.

In order to realize sensory effects, it is necessary to define a schema to express sensory effect information such as intensity of wind, color of light, and intensity of vibration in a standard format. Such a standardized schema for sensory effect information is referred as sensory effect metadata (SEM). When the sensory effect metadata is input to the RoSE engine 204 with the media 202, the RoSE engine 204 analyzes the sensory effect metadata that is described to realize sensory effects at predetermined times while reproducing the media 202. Further, the RoSE engine 204 controls sensory effect devices with being synchronized with the media 202.

The RoSE engine 204 needs to have information about various sensory devices in advance for representing sensory effects. Therefore, it is necessary to define metadata for expressing information about sensory effect devices. Such metadata is referred to as a sensory device capability metadata (SDCap). The sensory device capability metadata includes information about positions, directions, and capabilities of sensory devices.

A user who wants to reproduce media 202 may have various preferences for specific sensory effects. Such a preference may influence representation of sensory effects. For example, a user may not like a red color light. Or, when a user wants to reproduce media 202 in the middle of night, the user may want a dim lighting and a low sound volume. By expressing such preferences of a user about predetermined sensory effects as metadata, various sensory effects may be provided to a user. Such metadata is referred to as user sensory preference metadata (USP).

Before representing sensory effects, the RoSE engine 204 receives sensory effect capability metadata from each of sensory effect devices and user sensory preference metadata through an input device or from sensory effect devices. The RoSE engine 204 controls sensory effect devices with reference to the sensory effect capability metadata and the user sensory preference metadata USP. Such a control command is transferred to each of the sensory devices in a form of metadata. The metadata is referred to as a sensory device command metadata (SDCmd).

Hereinafter, a method and apparatus for representing sensory effects in accordance with an embodiment of the present invention will be described in detail.

### DEFINITIONS OF TERMS

### 1. Provider

The provider is an object that provides sensory effect metadata. The provider may also provide media related to the sensory effect metadata.

For example, the provider may be a broadcasting service provider

### 2. Representation of Sensory Effect (RoSE) Engine

The RoSE engine is an object that receives sensory effect metadata, sensory device capability metadata, user sensory preference metadata, and generates sensory device commands metadata based on the received metadata.

### 3. Consumer Devices

The consumer device is an object that receives sensory device command metadata and provides sensory device capability metadata. Also, the consumer device may be an object that provides user sensory preference metadata. The sensory devices are a sub-set of the consumer devices.

For example, the consumer device may be fans, lights, scent devices, and human input devices such as a television set with a remote controller.

### 4. Sensory Effects

The sensory effects are effects that augment perception by stimulating senses of human at a predetermined scene of multimedia application.

For example, the sensory effects may be scent, wind, and light.

### 5. Sensory Effect Metadata (SEM)

The sensory effect metadata (SEM) defines description schemes and descriptors for representing sensory effects

### 6. Sensory Effect Delivery Format

The sensory effect delivery format defines means for transmitting the sensory effect metadata (SEM).

For example, the sensory effect delivery format may be a MPEG2-TS payload format, a file format, and a RTP payload format.

### 7. Sensory Devices

The sensory devices are consumer devices for producing corresponding sensory effects.

For example, the sensory devices may be light, fans, and heater.

### 8. Sensory Device Capability

The sensory device capability defines description schemes and descriptors for representing properties of sensory devices.

For example, the sensory device capability may be an extensible markup language (XML) schema.

### 9. Sensory Device Capability Delivery Format

The sensory device capability delivery format defines means for transmitting sensory device capability.

For example, the sensory device capability delivery format may be hypertext transfer protocol (HTTP), and universal plug and play (UPnP).

### 10. Sensory Device Command

The sensory device command defines description schemes and descriptors for controlling sensory devices.

For example, the sensory device command may be a XML schema.

### 11. Sensory Device Command Delivery Format

The sensory device command delivery format defines means for transmitting the sensory device command.

For example, the sensory device command delivery format may be HTTP and UPnP.

### 12. User Sensory Preference

The user sensory preference defines description schemes and descriptors for representing user preferences about sensory effects related to rendering sensory effects.

For example, the user sensory preference may be a XML schema.

### 13. User Sensory Preference Delivery Format

The user sensory, preference delivery format defines means for transmitting user sensory preference.

For example, the user sensory preference delivery format may be HTTP and UPnP.

### <System for Representing Sensory Effects>

Hereinafter, an overall structure and operation of a system for representing sensory effects in accordance with an embodiment of the present invention will be described in detail.

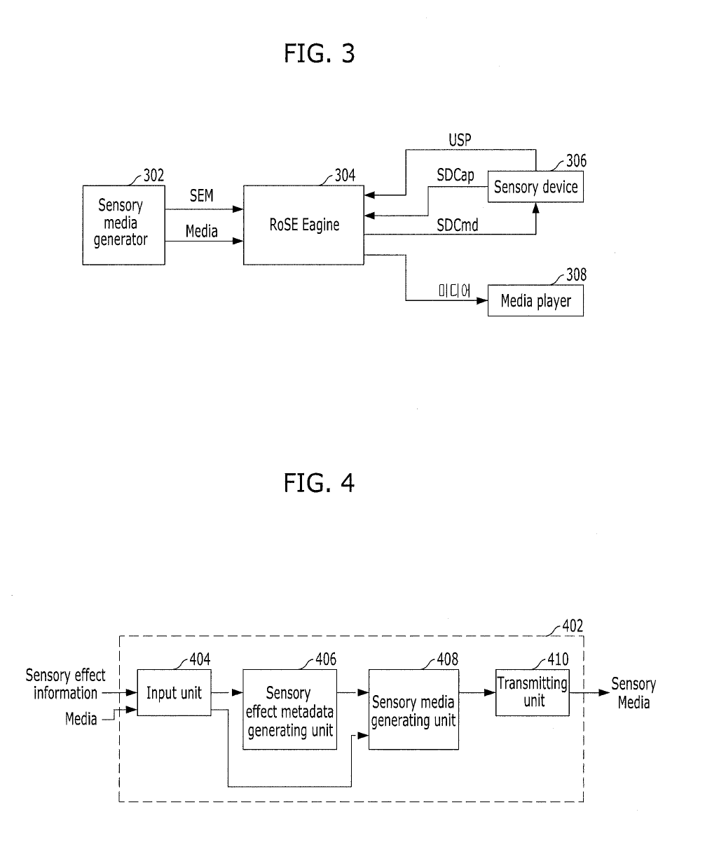

FIG. 3 is a diagram illustrating a single media multiple device (SMMD) system for representing sensory effects in accordance with an embodiment of the present invention.

Referring to FIG. 3, the SMMD system according to the present embodiment includes a sensory media generator 302, a representation of sensory effects (RoSE) engine 304, a sensory device 306, and a media player 308.

The sensory media generator 302 receives sensory effect information about sensory effects applied to media and generates sensory effect metadata (SEM) including the received sensory effect information. Then, the sensory media generator 302 transmits the generated sensory effect metadata to the RoSE engine 304. Here, the sensory media generator 302 may transmit media with the sensory effect metadata.

Although it is not shown in FIG. 3, a sensory media generator 302 according to another embodiment may transmit only sensory effect metadata. Media may be transmitted to the RoSE engine 304 or the media player 308 through additional devices. The sensory media generator 302 generates sensory media by packaging the generated sensory effect metadata with the media and may transmit the generated sensory media to the RoSE engine 304.

The RoSE engine 304 receives sensory effect metadata including sensory effect information about sensory effects applied to media and obtains sensory effect information by analyzing the received sensory effect metadata. The RoSE engine 304 controls the sensory device 306 of a user in order to represent sensory effects while reproducing media using the obtained sensory effect information. In order to control the sensory devices 306, the RoSE engine 304 generate the sensory device command metadata (SDCmd) and transmits the generated sensory device command metadata to the sensory device 306. In FIG. 3, one sensory device 306 is shown for convenience. However, a user may possess a plurality of sensory devices.

In order to generate the sensory device command metadata, the RoSE engine 304 needs information about capabilities of each sensory device 306. Therefore, before generating the sensory device command metadata, the RoSE engine 304 receives sensory device capability metadata (SDCap) that includes the information about capabilities of sensory devices 306. The RoSE engine 304 obtains information about states and capabilities of each sensory device 306 from the sensory device capability metadata. The RoSE engine 304 generates sensory device command metadata for realizing sensory effects that can be realized by each of sensory devices using the obtained information. Here, the controlling the sensory devices include synchronizing the sensory devices with scenes that are reproduced by the media player 308.

In order to control the sensory device 306, the RoSE engine 304 and the sensory device 306 may be connected through networks. Particularly, LonWorks or Universal Plug and Play technologies may be applied as the network technology. In order to effective provide media, media technologies such as MPEG including MPEG-7 and MPEG-21 may be applied together.

A user of the sensory device 306 and the media player 308 may have various preferences about predetermined sensory effects. For example, the user may dislike a predetermined color or may want strong vibration. Such user preference information may be input through the sensory device 306 or an additional input terminal (not shown). Further, the user preference information may be generated in a form of metadata. Such metadata is referred to as user sensory preference metadata USP. The generated user sensory preference metadata is transmitted to the RoSE engine 304 through the sensory device 306 or the input terminal (not shown). The RoSE engine 304 may generate sensory device command metadata in consideration of the received user sensory preference metadata.

The sensory device 306 is a device for realizing sensory effects applied to media. Particularly, the sensory device 306 includes exemplary devices as follows. However, the present invention is not limited thereto.
visual device: monitor, TV, wall screen.
sound device: speaker, music instrument, and bell
   wind device: fan, and wind injector.
   temperature device: heater and cooler
   Lighting device: light, dimmer, color LED, and flash
   shading device: curtain, roll screen, and door
   vibration device: trembling chair, joy stick, and ticker
   scent device: perfumer
   diffusion device: sprayer
   other device: devices that produce undefined effects and combination of the above devices

A user may have more than one of sensory devices 306. The sensory devices 306 receive the sensory device command metadata from the RoSE engine 304 and realize sensory effects defined in each scene by synchronizing it with the media.

The media player 308 is a device for reproducing media such as TV. Since the media player 308 is a kind of device for representing video and audio, the media reproduce 308 may be included in the sensory device 306. However, in FIG. 3, the media player 308 is independently shown for convenience. The media player 308 receives media from the RoSE engine 304 or through additional path and reproduces the received media.

### <Method and Apparatus for Generating Sensory Media>

Hereinafter, a method and apparatus for generating sensory media in accordance with an embodiment of the present invention will be described in detail.

The method for generating sensory media according to the present embodiment includes receiving sensory effect information about sensory effects applied to media; and generating sensory effect metadata including the sensory effect information. The sensory effect metadata includes sensory effect description information. The sensory effect description information includes media location information. The media location information describes about locations in media where sensory effects are applied to.

The method for generating sensory media according to the present embodiment further includes transmitting the generated sensory effect metadata to a RoSE engine. The sensory effect metadata may be transmitted as independent data separated from media. For example, when a user requests a movie service, a provider may transmit sensory effect metadata with media data (movie). If a user already has a predetermined media data (movie), a provider may transmit only corresponding sensory effect data applied to the media data.

The method for generating sensory media according to the present invention further includes generating sensory media by packaging the generated sensory effect metadata with media and transmitting the generated sensory media. A provider may generate sensory effect metadata for media, generate sensory media by combining or packaging the generated sensory effect metadata with media, and transmit the generated sensory media to the RoSE engine. The sensory media may be formed of files in a sensory media format for representing sensory effects. The sensory media format may be a file format to be defined as a standard for representing sensory effects.

In the method for generating sensory media according to the present embodiment, the sensory effect metadata includes sensory effect description information that describes sensory effects. The sensory effect metadata further includes general information about generation of metadata. The sensory effect description information includes media location information that shows locations in media where the sensory effects are applied to. The sensory effect description information further includes sensory effect segment information about segments of media. The sensory effect segment information may include effect list information about sensory effects to be applied to segments in media, effect variable information and segment location information representing locations where sensory effects are applied to. The effect variable information may include sensory effect fragment information containing at least one of sensory effect variables that are applied at the same time.

FIG. 4 is a diagram illustrating a sensory media generator in accordance with an embodiment of the present invention.

Referring to FIG. 4, the sensory media generator 402 includes an input unit 404 for receiving sensory effect information about sensory effects applied to media, and a sensory effect metadata generating unit 406 for generating sensory effect metadata including sensory effect information. The sensory effect metadata includes sensory effect description information that describes sensory effects. The sensory effect description information includes media location information that represents locations in media where sensory effects are applied to. The sensory media generator 402 further includes a transmitting unit 410 for transmitting sensory effect metadata to a RoSE engine. Here, the media may be input through the input unit 404 and transmitted to the RoSE engine or a media player through the transmitting unit 410. Alternatively, the media may be transmitted to the RoSE engine or the media player through an additional path without passing through the input unit 404.

Meanwhile, the sensory media generator 402 may further include a sensory media generating unit 408 for generating sensory media by packaging the generated sensory effect metadata with media. The transmitting unit 410 may transmit the sensory media to the RoSE engine. When the sensory media is generated, the input unit 404 receives the media. The sensory media generating unit 408 generates sensory media by combining or packaging the input media from the input unit 404 with the sensory effect metadata generated from the sensory effect metadata generating unit 406.

The sensory effect metadata includes sensory effect description information that describes sensory effects. The sensory effect metadata may further include general information having information about generation of metadata. The sensory effect description information may include media location information that shows locations in media where sensory effects are applied to. The sensory effect description information may further include sensory effect segment information about segments of media. The sensory effect segment information may include effect list information about sensory effects applied to segments of media, effect variable information, and segment location information that shows locations in segments where sensory effects are applied to. The effect variable information includes sensory effect fragment information. The sensory effect fragment information includes at least one of sensory effect variables that are applied at the same time.

### <Method and Apparatus for Representing Sensory Effects>

Hereinafter, a method and apparatus for representing sensory effects in accordance with an embodiment of the present invention will be described in detail.

The method for representing sensory effects according to the present embodiment includes receiving sensory effect metadata including sensory effect information about sensory effects applied to media, obtaining the sensory effect information by analyzing sensory effect metadata; and generating sensory device command metadata to control sensory devices corresponding to the sensory effect information. The method for representing sensory effects according to the present embodiment further includes transmitting the generated sensory effect command metadata to sensory devices. The sensory device command metadata includes sensory device command description information for controlling sensory devices.

The method for representing sensory effects according to the present embodiment further includes receiving sensory device capability metadata. The receiving sensory device capability metadata may further include referring to capability information included in the sensory device capability metadata.

The method for representing sensory effects according to the present embodiment may further include receiving user sensory preference metadata having preference information about predetermined sensory effects. The generating sensory device command metadata may further include referring to the preference information included in user sensory preference metadata.

In the method for representing sensory effects according to the present embodiment, the sensory device command description information included in the sensory device command metadata may include device command general information that includes information about whether a switch of a sensory device is turned on or off, about a location to setup, and about a direction to setup. Further, the sensory device command description information may include device command detail information. The device command detail information includes detailed operation commands for sensory devices.

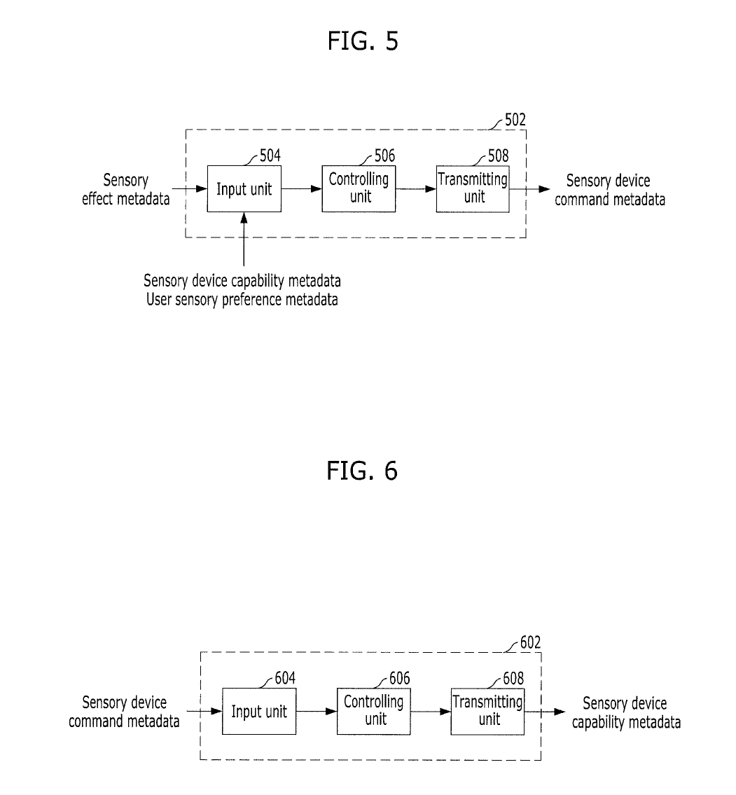

FIG. 5 is a block diagram illustrating an apparatus for representing sensory effects, which is referred to as a representation of sensory effects (RoSE) engine, in accordance with an embodiment of the present invention.

Referring to FIG. 5, the RoSE engine 502 according to the present embodiment includes an input unit 504 for receiving sensory effect metadata having sensory effect information about sensory effects applied to media, and a controlling unit 506 for obtaining sensory effect information by analyzing the received sensory effect metadata and generating sensory effect command metadata to control sensory devices corresponding to the sensory effect information. The sensory device command metadata includes sensory device command description information to control sensory devices. The RoSE engine 502 may further include a transmitting unit 508 for transmitting the generated sensory device command metadata to sensory devices.

The input unit 504 may receive sensory device capability metadata that include capability information about capabilities of sensory devices. The controlling unit 506 may refer to the capability information included in the sensory device capability metadata to generate sensory device command metadata.

The input unit 504 may receive user sensory preference metadata that includes preference information about preferences of predetermined sensory effects. The controlling unit 506 may refer to the preference information included in the user sensory preference metadata to generate the sensory device command metadata.

The sensory device command description information in the sensory device command metadata may include device command general information that includes information about whether a switch of a sensory device is turned on or off, about a location to setup, and about a direction to setup.

The sensory device command description information may include device control detail information including detailed operation commands for each sensory device.

### <Method and Apparatus for Providing Sensory Device Capability Information>

Hereinafter, a method and apparatus for providing sensory device capability information in accordance with an embodiment of the present invention will be described in detail.

The method for providing sensory device capability information according to the present embodiment includes obtaining capability information about sensory devices; and generating sensory device capability metadata including the capability information. The sensory device capability metadata includes device capability information that describes capability information. The method for providing sensory device capability information according to the present embodiment may further include transmitting the generated sensory device capability metadata to a RoSE engine.

Meanwhile, the method for providing sensory device capability information according to the present embodiment may further include receiving sensory device command metadata from the RoSE engine and realizing sensory effects using the sensory device command metadata. The RoSE engine generates the sensory effect device command metadata by referring to the sensory device capability metadata.

In the method for providing sensory device capability information according to the present embodiment, the device capability information in the sensory device capability metadata may include device capability common information that include information about locations and directions of sensory devices. The device capability information includes device capability detail information that includes information about detailed capabilities of sensory devices.

FIG. 6 is block diagram illustrating an apparatus for providing sensory device capability information in accordance with an embodiment of the present invention.

The apparatus 602 for providing sensory device capability information may be a device having the same function of a sensory device or may be a sensory device itself. The apparatus 602 may be a stand-alone device independent from a sensory device.

As shown in FIG. 6, the apparatus for providing sensory device capability metadata includes a controlling unit 606 for obtaining capability information about capabilities of sensory devices and generating the sensory device capability metadata including capability information. Here, the sensory device capability metadata includes device capability information that describes capability information. The apparatus for providing sensory device capability information according to the present embodiment further include a transmitting unit 608 for transmitting the generated sensory device capability metadata to the RoSE engine.

The apparatus 602 for providing sensory device capability information may further include an input unit 604 for receiving sensory device command metadata from the RoSE engine. The RoSE engine refers to the sensory device capability metadata to generate the sensory device command metadata. Here, the controlling unit 606 realizes sensory effects using the received sensory device control metadata.

Here, the device capability information included in the sensory device capability metadata may include device capability common information that includes information about locations and directions of sensory devices. The device capability information may include device capability detail information including information about detailed capabilities of sensory devices.

### <Method and Apparatus for Providing User Preference Information>

Hereinafter, a method and apparatus for providing user preference information in accordance with an embodiment of the present invention will be described.

The method for providing user preference information according to the present embodiment includes receiving preference information about predetermined sensory effects from a user, generating user sensory preference metadata including the received preference information. The user sensory preference metadata includes personal preference information that describes preference information. The method for providing user sensory preference metadata according to the present embodiment further includes transmitting the user sensory preference metadata to the RoSE engine.

The method for providing user sensory preference metadata according to the present embodiment may further include receiving sensory device command metadata from a RoSE engine and realizing sensory effects using sensory device command metadata. Here, the RoSE engine refers to the received user sensory preference metadata to generate the sensory device command metadata.

In the method for providing user sensory preference metadata according to the present embodiment, the preference information may include personal information for identifying a plurality of users and preference description information that describes sensory effect preference information of each user.

The preference description information may include effect preference information including detailed parameters for at least one of sensory effects.

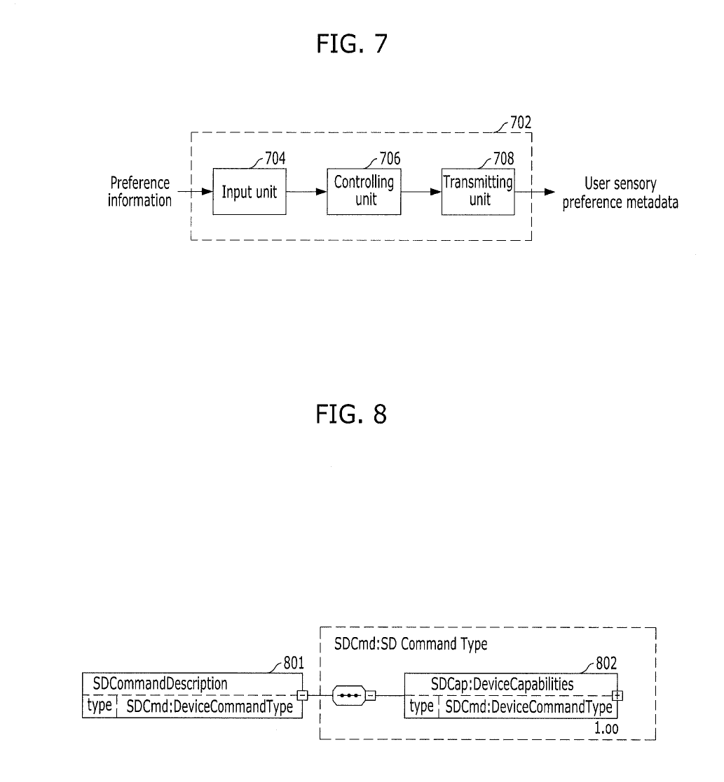

FIG. 7 is a block diagram illustrating an apparatus for providing user sensory preference information in accordance with an embodiment of the present invention.

The apparatus 702 for providing user sensory preference information according to the present embodiment may be a device having the same function of a sensory device or a sensory device itself. Also, the apparatus 702 may be a stand-alone device independent from the sensory device.

As shown in FIG. 7, the apparatus 702 for providing user sensory preference information according to the present embodiment includes an input unit 704 for receiving preference information about predetermined sensory effects from a user and a controlling unit 706 for generating user sensory preference metadata including the received preference information. The user sensory preference metadata includes personal preference information that describes the preference information. The apparatus 702 for providing user sensory preference information according to the present embodiment may further include a transmitting unit 708 for transmitting the generated user sensory preference metadata to the RoSE engine.

The input unit 704 may receive sensory device command metadata from the RoSE engine. The RoSE engine refers to the user sensory preference metadata to generate the sensory device command metadata. The controlling unit 706 may realize sensory effects using the received sensory device command metadata.

The personal preference information included in the user sensory preference metadata includes personal information for identifying each of users and preference description information that describes sensory effect preference of each user. The preference description information may further include effect preference information including detailed parameters about at least one of sensory effects.

### <Sensory Device Command Metadata>

Hereinafter, sensory device command metadata according to an embodiment of the present invention will be described in detail.

In order to generate command, a target sensory device ID is referred after obtained from sensory device capability metadata. An apparatus for representing sensory effects is aware of current directions and positions related to target sensory devices. The apparatus for representing sensory effects is also referred to as a representation of sensory effect (RoSE) engine. Sensory effect values obtained from the sensory effect metadata are converted to predetermined values by reflecting user sensory preference metadata and sensory device capability metadata.

The sensory device command metadata according to the present embodiment may be combined with a media related technology such as MPEG-7 and a network related technology such as LonWorks. As the network related technology such as LonWorks, Standard Network Variable Type (SNVTs) may be used. In this case, a namespace prefix may be used to identify a metadata type. A namespace of the sensory device command metadata according to the present embodiment is defined as “urn:SDCmd:verl:represent:SensoryDeviceCommand:2008-07”. Prefixes for corresponding predetermined namespaces are used for clarification. Table 1 shows prefixes and corresponding name spaces.

TABLE 1

| Prefix | Corresponding namespace |
|---|---|
| SDCmd | urn:SDCmd:ver1:represent:SensoryDeviceCommand:2008-07 |
| Snvt | urn:SNVT:ver1:Represent:VariableList:2007:09 |

Hereinafter, definitions and semantics of sensory device command metadata will be described in detail.

FIG. 8 is a diagram illustrating sensory device command metadata in accordance with an embodiment of the present invention.

Referring to FIG. 8, the sensory device command metadata SDCmd 1201 includes device command information DeviceCommand 1202. Table 2 shows the element of the sensory device command metadata (SDCmd) 1201 in detail.

TABLE 2

| Name | Definition |
|---|---|
| DeviceCommand | This element is the container for |
| | the device Commands. |

The device command information (DeviceCommand) 1202 is an element including commands for sensory devices.

A schema for sensory device command metadata (SDCmd) 1201 of FIG. 8 is exemplary shown as follows.

```
<element name=“SDCommandDescription”
type=“SDCmd:SDCommandType”/>
  <complexType name=“SDCommandType”>
    <sequence>
        <element  name=“DeviceCommand”
        type=“SDCmd:DeviceCommandType”
        maxOccurs=“unbounded”/>
    </sequence>
    </complexType>
```

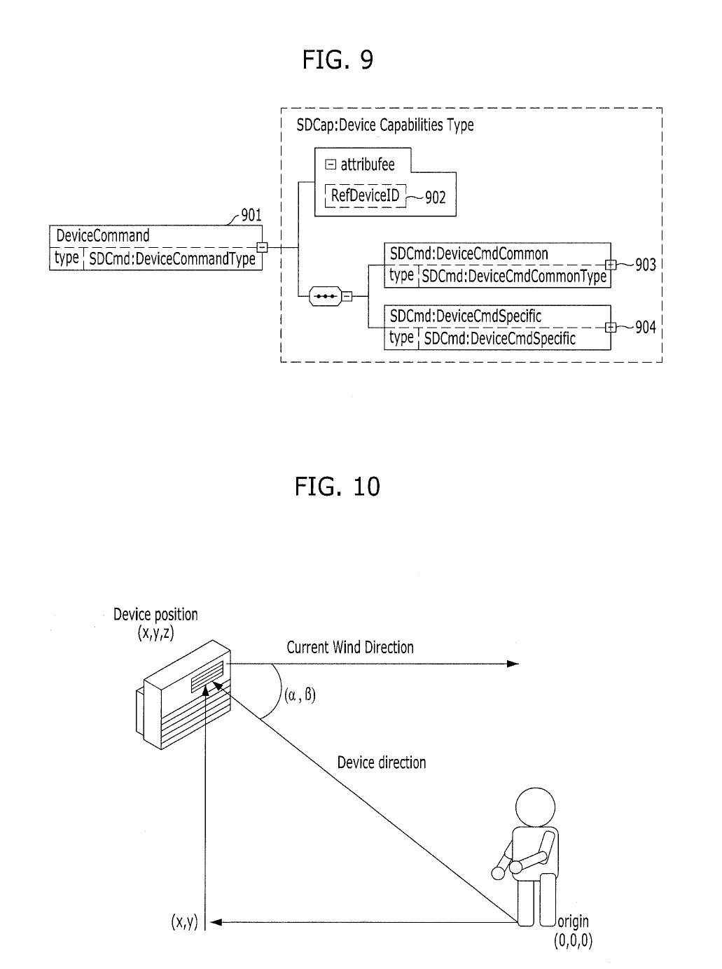

FIG. 9 is a diagram illustrating device command information (DeviceCommand) included in sensory device command metadata in accordance with an embodiment of the present invention.

The device command information (DeviceCommand) describes identifiers (ID) of target sensory devices obtained from sensory device capability metadata as an attribute. In order to describe commands, the device command information (DeviceCommand) includes two types of elements: commonly applicable elements and device specific elements. Referring to FIG. 9, the device command information (DeviceCommand) 901 may include following elements: a device reference ID (RedDevicelD) 902, a common device command (DeviceCmdCommon) 903, and a device specific command (DeviceCmdSpecific) 904. Table 3 shows these constituent elements of the device command information (DeviceCommand) 901 in detail.

TABLE 3

| Name | Definition |
|---|---|
| RefDeviceID | An attribute referring to ID of a target Sensory |
| | Device |
| DeviceCmdCommon | An element to describe commands commonly |
| | applicable to all Sensory Devices |
| DeviceCmdSpecific | An element to describe commands applicable to |
| | individual Sensory Device |

The device reference ID (RedDevicelD) 902 is an attribute referring to an ID of a target sensory device. The common device command (DeviceCmdCommon) 903 is an element describing commands commonly applicable to all sensory devices. The device specific command (DeviceCmdSpecific) 904 is an element that describes commands applicable to an individual sensory device.

A schema for the device command information (DeviceCommand) 901 of FIG. 9 is exemplary shown as follows.

```
<element name=“DeviceCommand”
type=“SDCmd:DeviceCommandType”/>
    <complexType name=“DeviceCommandType”>
        <sequence>
            <element  name=“DeviceCmdCommon”
            type=“SDCmd:DeviceCmdCommonType”/>
            <element  name=“DeviceCmdSpecific”
            type=“SDCmd:DeviceCmdSpecificType”/>
        </sequence>
        <attribute name=“RefDeviceID”/>
    </complexType>
```

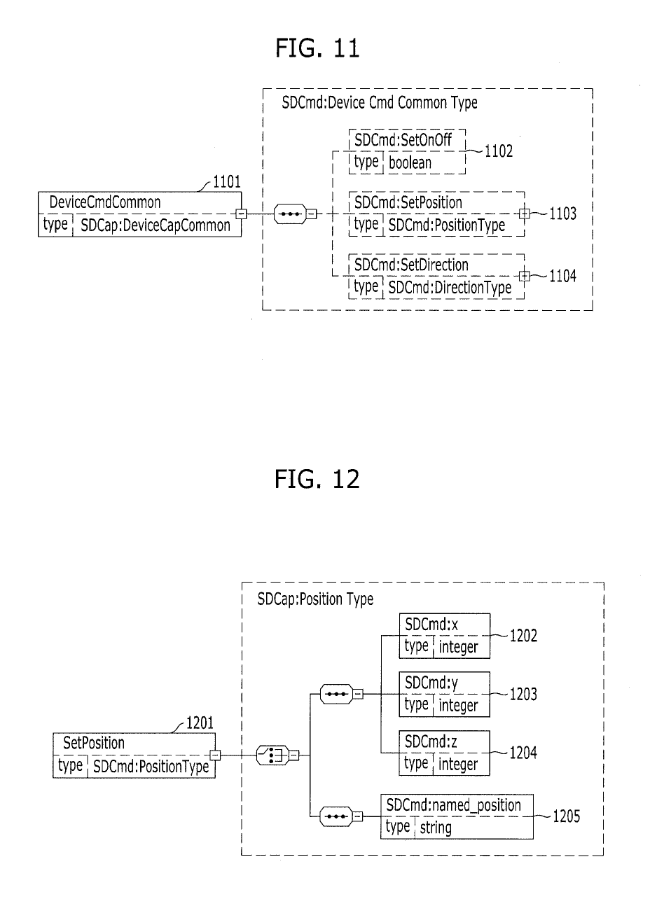

FIG. 10 is a diagram illustrating a method for measuring a direction and a position of a sensory device in accordance with an embodiment of the present invention. FIG. 11 is a diagram illustrating a common device command (DeviceCmdCommon) included in sensory device command metadata in accordance with an embodiment of the present invention.

The common device command (DeviceCmdCommon) is an element that describes commands commonly applicable to all of sensory devices. The common device command (DeviceCmdCommon) includes setting information related to sensory devices such as On/Off switching states, positions, and directions of sensory devices. The directions and positions may be calculated through the measuring method of FIG. 10. The position of a predetermined sensory device is calculated from an origin which is a right tiptoe of a user. An angle of a predetermined device is calculated based on a horizontal/vertical angles (α, β) between a device direction and a current wind direction.

Referring to FIG. 11, the common device command (DeviceCmdCommon) 1101 may include following elements: SetOnOff 1102, SetPosition 1103, and SetDirection 1104. Table shows these constituent elements of the common device command (DeviceCmdCommon) 1101 in detail.

TABLE 4

| Name | Definition |
|---|---|
| SetOnOff | This element describes switching on or off of the Sensory |
| | Device. |
| SetPosition | This element describes the position to be set. |
| SetDirection | This element describes where a target Sensory Device is |
| | aiming for. |

SetOnOff 1102 is an element that describes on/off switching states of a sensory device. SetPosition 1103 is an element describing a position of a sensory device to set. SetDirection 1104 is an element describing a direction that a target sensory device faces toward.

A schema for common device command (DeviceCmdCommon) 1101 of FIG. 11 is exemplary shown as follows.

| | |
|---|---|
| <element | name=“DeviceCmdCommon” |

```
type=“SDCmd:DeviceCmdCommonType”/>
    <complexType name=“DeviceCmdCommonType”>
        <sequence>
            <element name=“SetOnOff” type=“boolean”
            minOccurs=“0”/>
            <element  name=“SetPosition”
            type=“SDCmd:PositionType” minOccurs=“0”/>
            <element  name=“SetDirection”
            type=“SDCmd:DirectionType” minOccurs=“0”/>
        </sequence>
    </complexType>
```

FIG. 12 is a diagram illustrating an element SetPosition included in sensory device command metadata in accordance with an embodiment of the present invention.

Referring to FIG. 12, SetPosition 1201 may include following sub-elements: an x value (x) 1202, a y value (Y) 1203, and a z value (Z) 1204. SetPosition 1201 may further include named_position 1205.

TABLE 5

| Name | Definition |
|---|---|
| x | x centimeter from a user |
| y | y centimeter from a user |
| z | z centimeter from a user |
| <named_position | Simple descriptions of Position. |

A schema for SetPosition 1201 of FIG. 12 is exemplary shown as follows.

```
<element name=“SetPosition” type=“SDCmd:PositionType”/>
    <complexType name=“PositionType”>
        <choice>
            <sequence>
                <element name=“x” type=“integer”/>
                <element name=“y” type=“integer”/>
                <element name=“z” type=“integer”/>
            </sequence>
            <sequence>
                <element name=“named_position”>
                    <simpleType>
                        <restriction base=“string”>
                            <enumeration
                            value=“Front”/>
                            <enumeration
                            value=“RightFront”/>
                            <enumeration
                            value=“Right”/>
                            <enumeration
                            value=“RightRear”/>
                            <enumeration
                            value=“Rear”/>
                            <enumeration
                            value=“LeftRear”/>
                            <enumeration
                            value=“Left”/>
                            <enumeration
                            value=“LeftFront”/>
                            <enumeration
                            value=“Above”/>
                            <enumeration
                            value=“Below”/>
                        </restriction>
                    </simpleType>
                </element>
            </sequence>
        </choice>
    </complexType>
```

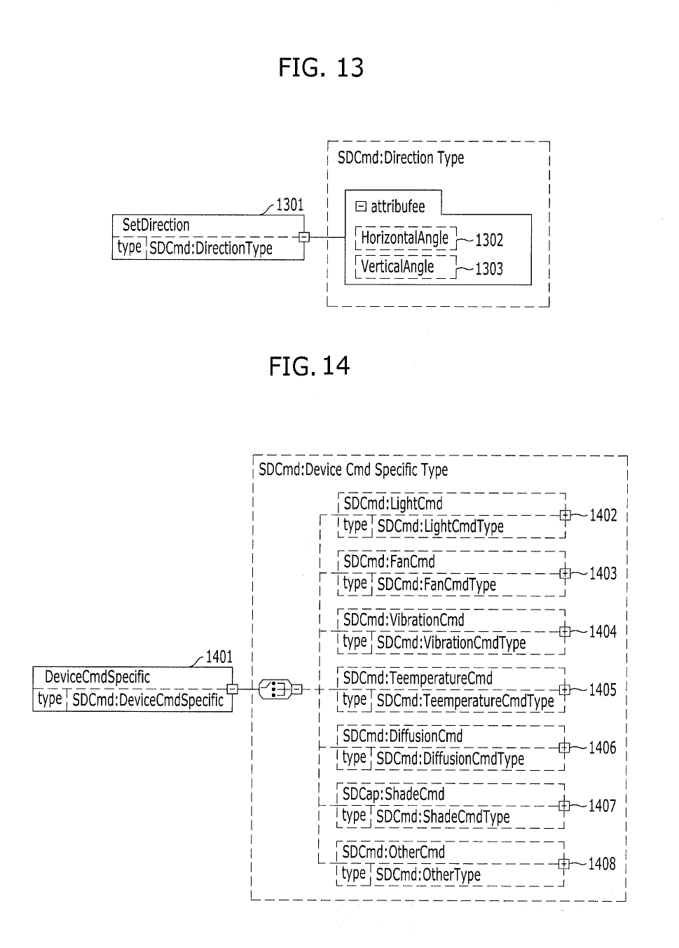

FIG. 13 is a diagram illustrating an element SetDirection included in sensory device command metadata in accordance with an embodiment of the present invention.

SetDirection is an element that describes a direction that a target sensory device faces toward.

Referring to FIG. 13, SetDirection 1301 may include following elements: HorizontalAngle 1302 and VerticalAngle 1303. Table 6 shows these elements of SetDirection 1301 in detail.

TABLE 6

| Name | Definition |
|---|---|
| HorizontalAngle | The attribute describes a target horizontal angel in |
| | degree. |
| VerticalAngle | The attribute describes a target vertical angel in |
| | degree. |

HorizontalAngle 1302 is an attribute that describes a target horizontal angle in degree. VerticalAngle 1303 is an attribute that describes a target vertical angle in degree.

A schema for SetDirection 1301 of FIG. 13 is exemplary shown as follows.

```
<element name=“SetDirection” type=“SDCmd:DirectionType”/>
    <complexType name=“DirectionType”>
        <attribute  name=“HorizontalAngle”
        type=“SDCmd:AngleType” use=“optional”/>
        <attribute  name=“VerticalAngle”
        type=“SDCmd:AngleType” use=“optional”/>
    </complexType>
```

FIG. 14 is a diagram illustrating a device specific command (DeviceCmdSpecific) included in sensory device command metadata in accordance with an embodiment of the present invention.

The device specific command (DeviceCmdSpecific) is an element that describes commands applicable to each of individual sensory devices such as a light device, a fan, a temperature device, a vibration device, a diffusion device, and a shade device. Referring to FIG. 14, the device specific command information (DeviceCmdSpecific) 1401 may include following elements: a light device control command (LightCmd) 1402, a fan control command (FanCmd) 1403, a vibration device control command (VibrationCmd) 1404, a temperature device control command (TemperatureCmd) 1405, a diffusion device control command (DiffusionCmd) 1406, a shade device control command (ShadingCmd) 1407, and other device control command (OtherCmd) 1408. Table 7 shows theses constituent elements of the device command specific information (DeviceCmdSpecific).

TABLE 7

| Name | Definition |
|---|---|
| LightCmd | This element describes the commands for Light |
| | device. |
| FanCmd | This element describes the commands for Fan |
| | device. |
| TempereatureCmd | This element describes the commands for |
| | Tempereature device. |
| VibrationCmd | This element describes the commands for Vibration |
| | device. |
| DiffusionCmd | This element describes the commands for Diffusion |
| | device. |
| ShadeCmd | This element describes the commands for Shade |
| | device. |
| OtherCmd | This element describes the commands for other |
| | sensory device. |

The light device control command (LightCmd) 1402 is an element describes commands for controlling a light device. The fan control command (FanCmd) 1403 describes commands for controlling a fan. The vibration device control command (VibrationCmd) 1404 is an element describing commands for controlling a vibration device. The temperature device control command (TemperatureCmd) 1405 is an element describing commands for controlling a temperature device. The diffusion device control command (DiffusionCmd) 1406 is an element describing commands for controlling a diffusion device. The shade device control command (ShadingCmd) 1407 is an element describing commands for controlling a shade device. The other device control command (OtherCmd) 1408 is an element describing commands for controlling other sensory devices.

A schema for device specific command (DeviceCmdSpecific) 1401 of FIG. 14 is exemplary shown as follows.

| | |
|---|---|
| <element | name=“DeviceCmdSpecific” |

```
type=“SDCmd:DeviceCmdSpecificType”/>
    <complexType name=“DeviceCmdSpecificType”>
        <choice>
            <element  name=“LightCmd”
            type=“SDCmd:LightCmdType” minOccurs=“0”/>
            <element  name=“FanCmd”
            type=“SDCmd:FanCmdType” minOccurs=“0”/>
            <element  name=“VibrationCmd”
            type=“SDCmd:VibrationCmdType” minOccurs=“0”/>
            <element  name=“TemperatureCmd”
            type=“SDCmd:TemperatureCmdType”
            minOccurs=“0”/>
            <element  name=“DiffusionCmd”
            type=“SDCmd:DiffusionCmdType” minOccurs=“0”/>
            <element  name=“ShadingCmd”
            type=“SDCmd:ShadingCmdType” minOccurs=“0”/>
            <element  name=“OtherCmd”
            type=“SDCmd:OtherType” minOccurs=“0”/>
        </choice>
    </complexType>
```

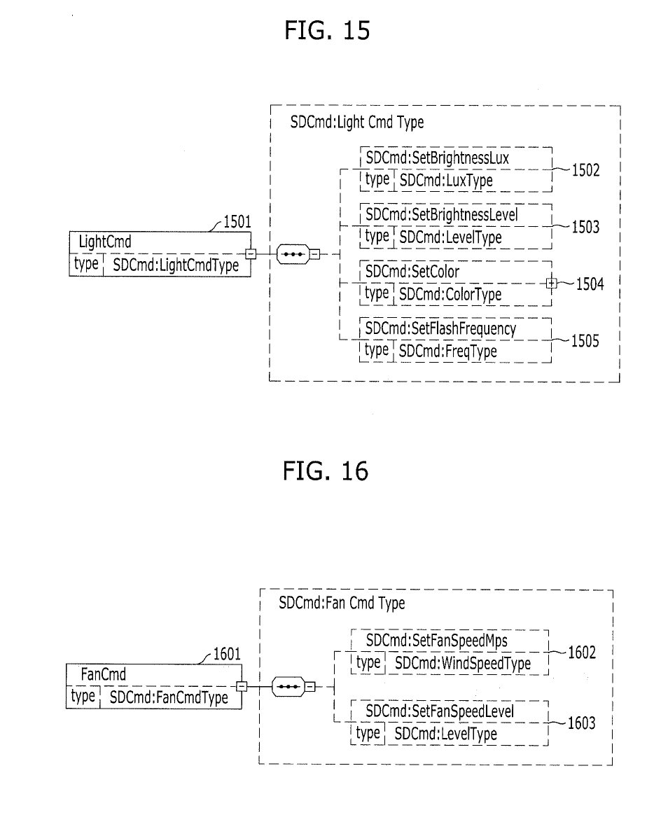

FIG. 15 is a diagram illustrating a light device control command (LightCmd) included in sensory device command metadata in accordance with an embodiment of the present invention.

Referring to FIG. 15, the light device control command (LightCmd) 1501 may include following elements: SetBrightnessLux 1502, SetBrightnessLevel 1503, SetColor 1504, and SetFlashFrequency 1505. Table 8 shows theses elements of the light device control command (LightCmd) 1501 in detail.

TABLE 8

| Name | Definition |
|---|---|
| SetBrightness | An optional element setting brightness that a Light Device can act in LUX. The |
| Lux | type is SEM:LuxType. |
| SetBrightness | An optional element setting brightness that a Light Device can act in level. The |
| Level | type is SEM:LevelType. |
| SetColor | An optional element setting a color of the Sensory Device. 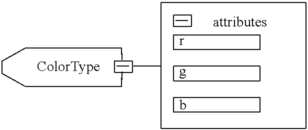 A particular color is defined by a combination values of red, green, and blue. |
| SetFlashFrequency | An optional element defining flickering frequency that Flash can act in Hz. The |
| | type is SEM:FreqType. |

SetBrightnessLux 1502 is an optional element for setting the brightness of a light device in a unit of LUX. A type of SetBrightnessLux 1502 is LuxType. SetBrightnessLevel 1503 is an optional element for setting the brightness of a light device in a unit of level. A type of SetBrightnessLux 1502 is LevelType. SetColor 1504 is an optional element for setting a color of a sensory device. As show in Table 8, SetColor 1504 defines a predetermined color by a combination value of red (R), green (g), and blue (b). SetFlashFrequency 1505 is an optional element that defines a flickering frequency of a flash in a unit of Hz. A type of SetFlashFrequency 1505 is FreqType.

A schema for a light device control command (LightCmd) 1501 of FIG. 15 is exemplary shown as follows.

```
<element name=“LightCmd” type=“SDCmd:LightCmdType”/>
    <complexType name=“LightCmdType”>
        <sequence>
            <element  name=“SetBrightnessLux”
            type=“SDCmd:LuxType” minOccurs=“0”/>
            <element  name=“SetBrightnessLevel”
            type=“SDCmd:LevelType” minOccurs=“0”/>
            <element  name=“SetColor”
            type=“SDCmd:ColorType” minOccurs=“0”/>
            <element  name=“SetFlashFrequencyHz”
            type=“SDCmd:FreqType” minOccurs=“0”/>
        </sequence>
    </complexType>
```

FIG. 16 is a diagram illustrating a fan control command (FanCmd) included in sensory device command metadata in accordance with an embodiment of the present invention.

Referring to FIG. 16, the fan control command (FanCmd) 1601 includes following elements: SetFanSpeedMps 1602, and SetFanSpeedLevel 1603. Table 9 shows these constituent elements of the fan control command (FanCmd) 1601.

TABLE 9

| Name | Definition |
|---|---|
| SetFanSpeedMps | An optional element setting a speed that Fan can act in |
| | Mps (Meter per second). |
| | The type is SEM:WinSpeedType. |
| SetfanSpeedLevel | An optional element setting a speed that Fan can act in |
| | level. The type is SEM:LevelType. |

SetFanSpeedMps 1602 is an optional element for setting a speed of a fan in a unit of MPS (meter per second). A type of SetFanSpeedMps 1602 is WinSpeedType. SetFanSpeedLevel 1603 is an optional element for setting a speed of fan in a unit of level. A type of SetFanSpeedMps 1602 is LevelType.

A schema for a fan control command (FanCmd) of 1601 is exemplary shown as follows.

```
<element name=“FanCmd” type=“SDCmd:FanCmdType”/>
    <complexType name=“FanCmdType”>
        <sequence>
            <element  name=“SetFanSpeedMps”
            type=“SDCmd:WindSpeedType” minOccurs=“0”/>
            <element  name=“SetFanSpeedLevel”
            type=“SDCmd:LevelType” minOccurs=“0”/>
        </sequence>
    </complexType>
            <element  name=“VibrationCmd”
            type=“SDCmd:VibrationCmdType”/>
    <complexType name=“VibrationCmdType”>
        <sequence>
            <element  name=“SetVibrationFreqHz”
            type=“SDCmd:FreqType” minOccurs=“0”/>
            <element  name=“SetVibrationAmpMm”
            type=“unsignedInt” minOccurs=“0”/>
            <element  name=“SetVibrationLevel”
            type=“SDCmd:LevelType” minOccurs=“0”/>
        </sequence>
    </complexType>
```

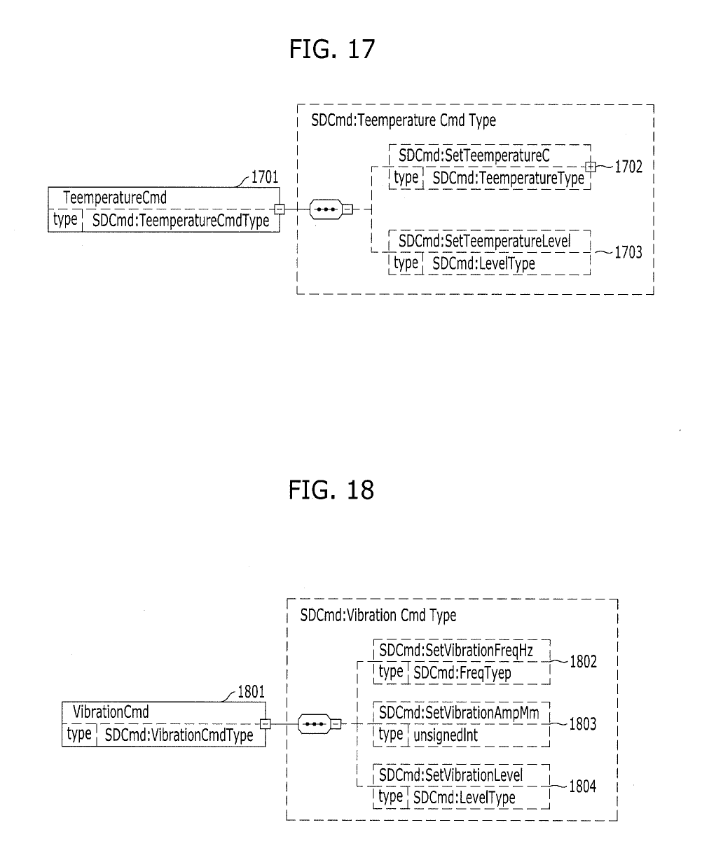

FIG. 17 is a diagram illustrating a temperature device control command (TemperatureCmd) included in sensory device command metadata in accordance with an embodiment of the present invention.

Referring to FIG. 17, the temperature device control command (TemperatureCmd) 1701 may include following elements: SetTemperatureC 1702 and SetTemperatureLevel 1703. Table 10 shows these constituent elements of the temperature device control command (TemperatureCmd) in detail.

TABLE 10

| Name | Definition |
|---|---|
| SetTemperatureC | An optional element setting a temperature that |
| | Sensory Device can act in Celsius |
| SetTemperatureLevel | An optional element setting a temperature that |
| | Sensory Device can act in Celsius |

SetTemperatureC 1702 is an optional element for setting a temperature that a temperature device can act in a unit of Celsius. SetTemperatureLevel 1703 is an optional element setting a temperature that a temperature device can act in a unit of a level.

A schema for a temperature device control command (TemperatureCmd) 1701 of FIG. 17 is exemplary shown as follows.

```
<element name=“TemperatureCmd”
type=“SDCmd:TemperatureCmdType”/>
    <complexType name=“TemperatureCmdType”>
        <sequence>
            <element  name=“SetTemperatureC”
            type=“SDCmd:TemperatureType” minOccurs=“0”/>
            <element  name=“SetTemperatureLevel”
            type=“SDCmd:LevelType” minOccurs=“0”/>
        </sequence>
    </complexType>
```

FIG. 18 is a diagram illustrating a vibration device control command (VibrationCmd) included in sensory device command metadata in accordance with an embodiment of the present invention.

Referring to FIG. 18, the vibration device control command (VibrationCmd) 1810 may include following elements: SetVibrationFreqHz 1802, SetVibrationAmpMm 1803, and SetVibrationLevel 1804. Table 11 shows these elements of the vibration device control command (VibrationCmd) in detail.

TABLE 11

| Name | Definition |
|---|---|
| SetVibrationFreqHz | An optional element setting frequency that |
| | vibration device can act in Hz. The type is |
| | SEM:FreqType. |
| SetVibrationAmpMm | An optional element setting amplitude that |
| | vibration device can act in Millimeter. The type is |
| | unsigned integer. |
| SetVibrationLevel | An optional element setting intensity level that |
| | vibration device can act. The type is |
| | SEM:LevelType. |

SetVibrationFreqHz 1802 is an optional element for setting a frequency of a vibration device in a unit of Hz. A type of SetVibrationFreqHz 1802 is FreqType. SetVibrationAmpMm 1803 is an optional element for setting an intensity of a vibration device in a milligram unit. A type of SetVibrationAmpMm 1803 is an unsigned integer. SetVibrationLevel 1804 is an optional element for setting an intensity level of a vibration device. A type of SetVibrationLevel 1804 is LevelType.

A schema for a vibration device control command (VibrationCmd) 1810 of FIG. 18 is exemplary shown as follows.

```
<element name=“VibrationCmd” type=“SDCmd:VibrationCmdType”/>
    <complexType name=“VibrationCmdType”>
        <sequence>
            <element  name=“SetVibrationFreqHz”
            type=“SDCmd:FreqType” minOccurs=“0”/>
            <element  name=“SetVibrationAmpMm”
            type=“unsignedInt” minOccurs=“0”/>
            <element  name=“SetVibrationLevel”
            type=“SDCmd:LevelType” minOccurs=“0”/>
        </sequence>
    </complexType>
```

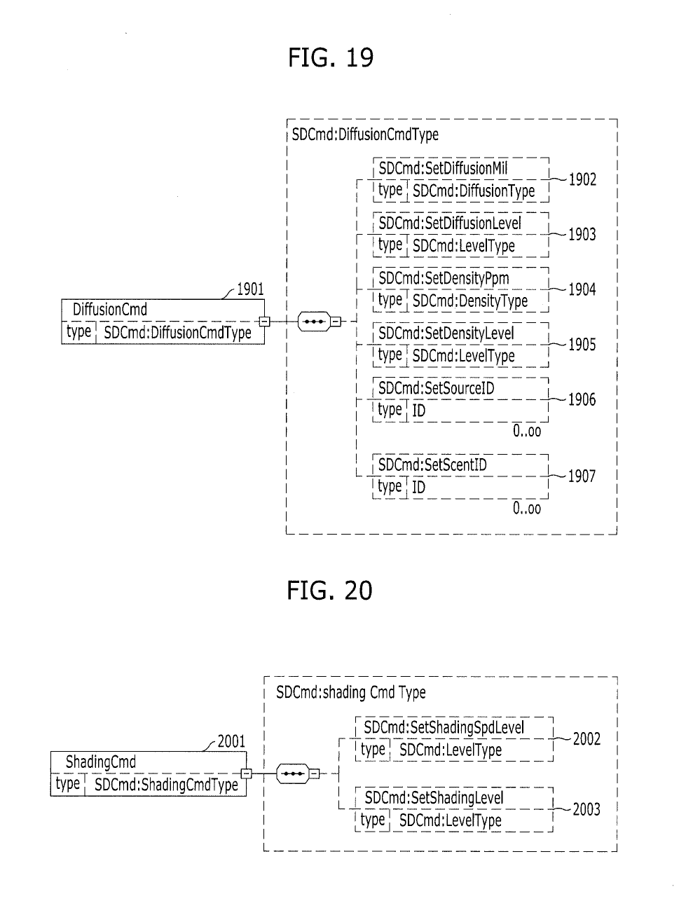

FIG. 19 is a diagram illustrating a diffusion device control command (DiffusionCmd) included in sensory device command metadata in accordance with an embodiment of the present invention.

Referring to FIG. 19, the diffusion device control command (DiffusionCmd) 1901 may include following elements: SetDiffusionmMil 1902, SetDiffusionLevel 1903, SetDensityPpm 1904, SetDensityLevel 1905, SetSouceID 1906, and SetScentID 1907. Table 12 shows these constituent elements of diffusion device control command (DiffusionCmd) in detail.

TABLE 12

| Name | Definition |
|---|---|
| SetDiffusionMil | An optional element setting quantity that diffusion |
| | device can act in Milligram |
| SetDiffusionLevel | An optional element setting level that diffusion device |
| | can act |
| SetDensityPpm | An optional element setting density that diffusion |
| | device can act in Ppm |
| SetDensityLevel | An optional element setting density level that diffusion |
| | device can act |
| SetSourceID | An optional element setting source ID that a diffusion |
| | device has. A diffusion device may have multiple |
| | sources |
| SetScentID | An optional element setting scent ID that a scent |
| | device has. A scent device may have multiple sources |

SetDiffusionmMil 1902 is an optional element for setting quantity that a diffusion device can act in a milligram unit. SetDiffusionLevel 1903 is an optional element for setting a level of a diffusion device. SetDensityPpm 1904 is an optional element for setting a density that a diffusion device can act in a unit of Ppm. SetDensityLevel 1905 is an optional element for setting a density level that a diffusion device can act. SetSouceID 1906 is an optional element for setting a source ID of a diffusion device. SetScentID 1907 is an optional element for setting a scent ID of a scent device. A scent device may have a plurality of sources.

A schema for a diffusion device control command (DiffusionCmd) 1901 of FIG. 19 is exemplary shown as follows.

```
<element name=“DiffusionCmd” type=“SDCmd:DiffusionCmdType”/>
    <complexType name=“DiffusionCmdType”>
        <sequence>
            <element  name=“SetDiffusionMil”
            type=“SDCmd:DiffusionType” minOccurs=“0”/>
            <element  name=“SetDiffusionLevel”
            type=“SDCmd:LevelType” minOccurs=“0”/>
            <element  name=“SetDensityPpm”
            type=“SDCmd:DensityType” minOccurs=“0”/>
            <element  name=“SetDensityLevel”
            type=“SDCmd:LevelType” minOccurs=“0”/>
            <element  name=“SetSourceID” type=“ID”
            minOccurs=“0” maxOccurs=“unbounded”/>
            <element  name=“SetScentID” type=“ID”
            minOccurs=“0” maxOccurs=“unbounded”/>
        </sequence>
    </complexType>
```

FIG. 20 is a diagram illustrating a shad device control command (ShadingCmd) included in sensory device command metadata in accordance with an embodiment of the present invention.

Referring to FIG. 20, the shade device control command (ShadingCmd) 2001 may include following elements: SetShadingSpdLevel 2002 and SetShadingLevel 2003. Table 13 shows these constituent elements of a shade device control command (ShadingCmd) in detail.

TABLE 13

| Name | Definition | |
|---|---|---|
| ShadingCmdType | An optional element having enumeration set of the | |
| | shading mode of Sensory Device | |
| | Enumeration Value | Description |
| | “SideOpen” | Curtain type |
| | “RollOpen” | Roll screen type |
| | “PullOpen” | Pull door type |
| | “PushOpen” | Push door type |

| | |
|---|---|
| SetShadingSpdLevel | An optional element setting shading speed level that |
| | a shading device can act. |
| SetShadingLevel | An optional element setting shading level that a |
| | shading device can act. |

SetShadingSpdLevel 2002 is an optional element for setting a shading speed level of a shade device. SetShadingLevel 2003 is an optional element for setting a shading level of a shade device.

A schema for a diffusion device control command (DiffusionCmd) 1901 of FIG. 20 is exemplary shown as follows.

```
<element name=“ShadingCmd” type=“SDCmd:ShadingCmdType”/>
    <complexType name=“ShadingCmdType”>
        <sequence>
            <element  name=“SetShadingSpdLevel”
            type=“SDCmd:LevelType” minOccurs=“0”/>
            <element  name=“SetShadingLevel”
            type=“SDCmd:LevelType” minOccurs=“0”/>
        </sequence>
    </complexType>
```

Table 14 shows simple types. It is necessary to restrict an intensity value of sensory effect for safety purpose. In the present embodiment, a simple type for each sensory effect measurement unit is defined and it is referred in user sensory preference metadata.

TABLE 14

| Name | Definition & Source |
|---|---|
| LuxType | This simple type represents degree of brightness using lux. The restriction base |
| | is the snvt:luxType. The value is restricted from 0 to 5000 lux. |
| | <simpleType name=“LuxType”> |
| | <restriction base=“snvt:luxType”> |
| | <maxInclusive value=“5000”/> |
| | </restriction> |
| | </simpleType> |
| AngleType | This simple type represents the dregree of the angle. The restriction base is the |
| | snvt:angle_degType. The value is restricted from −359.9 to 360. |
| | <simpleType name=“AngleType”> |
| | <restriction base=“snvt:angle degType”> |
| | <minInclusive value=“−359.9”/> |
| | <maxInclusive value=“360.0”/> |
| | </restriction> |
| | </simpleType> |
| TemperatureType | This simple type represents the temperature using centigrade. The restriction |
| | base is the snvt:temp pType. The value is restricted from 0 to 45. |
| | <simpleType name=“TemperatureType”> |
| | <restriction base=“snvt:temp_pType”> |
| | <minInclusive value=“−15”/> |
| | <maxInclusive value=“45”/> |
| | </restriction> |
| | </simpleType> |
| VibrationType | This simple type represents the intensity of vibration using rpm. The restriction |
| | base is the snvt:rpm Type. The value is restricted from 0 to 20000. |
| | <simpleType name=“VibrationType”> |
| | <restriction base=“snvt:rpm_Type”> |
| | <maxInclusive value=“20000”/> |
| | </restriction> |
| | </simpleType> |
| WindSpeedType | This simple type represents speed of wind using meter per second. The |
| | restriction base is the snvt:speed_milType. The value is restricted from |
| | 0 to 20. |
| | <simpleType name=“WindSpeedType”> |
| | <restriction base=“snvt:speed_milType”> |
| | <maxInclusive value=“20”/> |
| | </restriction> |
| | </simpleType> |
| DensityType | This simple type represents the density of the diffusion source using parts per |
| | million. The restriction base is the snvt:ppmType. |
| | <simpleType name=“DensityType”> |
| | <restriction base=“snvt:ppmType”/> |
| | </simpleType> |
| DiffusionType | This simple type represents diffusion. The restriction base is the |
| | snvt:mass_milType. The value is restricted from 0 to 20000. |
| | <simpleType name=“DiffusionType”> |
| | <restriction base=“snvt:rnass_milType”> |
| | <maxInclusive value=“200”/> |
| | </restriction> |
| | </simpleType> |
| FreqType | This simple type represents frequency using Hz. The restriction base is the |
| | snvt:rmp_Type. The value is restricted from 0 to 20000. |
| | <simpleType name=“FrequencyType”> |
| | <restriction base=“snvt:freq_hzType”/> |
| | </simpleType> |
| LevelType | This simple type represents level of the sensory effect intensity. The value is |
| | restricted from 0 to 100. |
| | The restriction base is the unsignedInt. |
| | <simpleType name=“LevelType”> |
| | <restriction base=“unsignedInt”> |
| | <minInclusive value=“0”/> |
| | <maxInclusive value=“100”/> |
| | </restriction> |
| | </simpleType> |

Hereinafter, a definition and semantic of a SNVT schema related to LonWorks will be described.

LonWorks provides an open networking platform formed of a protocol designed by Echelon Corporation for networking devices connected through twisted pairs, power lines and fiber optics. LonWorks defines (1) a dedicated microprocessor known as an neuron chip which is highly optimized for devices on control network, (2) a transceiver for transmitting protocols on predetermined media such as twisted pairs or power lines, (3) a network database which is an essential software component of an open control system (which is also known as LNS network operating system), and (4) internet connection with standard network variable types (SNVTs). One of elements for interoperability in LonWorks is the standardization of SNVTs. For example, a thermostat using temperature SNVT has values between 0 to 65535 which are equivalent to a temperature range of −274° C. to 6279.5° C. DRESS media is rendered through devices that can be controlled by media metadata for special effect. A metadata schema for describing special effects may be designed based on a set restricted within SNVT data type for device control. Table 15 shows SNVT expression in LonWorks.

TABLE 15

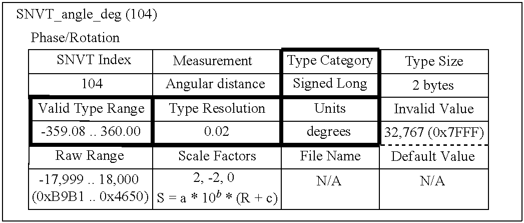

In Table 15, boxes surrounded with a bold line are translated to a XML schema. The box Type Category expresses a variable type using predefined variable types such as unsignedInt, float, decimal and Boolean. The box Valid type Range limits a range of values and the box Type Resolution defines a resolution to express a value. The box Units denotes a unit to express SNVT type. In case of SNVT_angle_deg, a proper unit thereof is degrees.

Table 16 describes SNVTs translated to XML schema.

TABLE 16

| Name | Definition | | | |
|---|---|---|---|---|
| SNVT_lux | SNVT_lux describes illumination using lux. The type of SNVT_lux is snvt:luxType. | | | |
| | The following table is provided in LonMark web site. | | | |
| | Illumination (luminous-flux intensity) | | | |
| | 1 lux = 1 lumen·m² | | | |
| | As a comparison: 1 foot-candle = 1 lumen/ft². 1 foot-candle = 10.76 lux. | | | |
| | SNVT Index | Measurement | Type Category | Type Size |
| | 79 | Illumination | Unsigned Long | 2 bytes |
| | Valid Type Range | Type Resolution | Units | invalid Value |
| | 0 . . . 65,335 | 1 | Lux | |
| | Raw Range | Scale Factors | File Name | Default Value |
| | 0 . . . 65,535 | 1, 0, 0 | N/A | N/A |
| | (0 . . . 0xFFFF) | S = a * 10^{b} * (R + c) | | |
| | According to the definition, we design snvt:luxType. | | | |
| | <simpleType name=“luxType”> | | | |
| | <restriction base=“unsignedInt> | | | |
| | <minInclusive value=“0”/> | | | |
| | <maxInclusive value=“65534”/> | | | |
| | </restriction> | | | |
| | </simpleType> | | | |
| SNVT_speed_mil | SNVT_Speed_mil describes linear velocity as m/s(meters/sec). The type of | | | |
| | SNVT_speed_mil is snvt:speed_mil Type. | | | |
| | Linear Velocity | | | |
| | SNVT Index | Measurement | Type Category | Type Size |
| | 35 | Linear Velocity | Unsigned Long | 2 bytes |
| | Valid Type Range | Type Resolution | Units | Invalid Value |
| | 0 . . . 65,535 | 0.001 | Meters per Second | |
| | | | (m/s) | |
| | Raw Range | Scale Factors | File Name | Default Value |
| | 0 . . . 65,535 | 1.−3.0 | N/A | N/A |
| | (0 . . . 0xFFFF) | S = a * 10^{b} * (R + c) | | |
| | According to the definition, we design snvt:speed_milType. | | | |
| | <simpleType name=“speed_milType”> | | | |
| | <restriction base=“float”> | | | |
| | <minInclusive value=“0”/> | | | |
| | <maxInclusive value=“65,535”/> | | | |
| | <fractionDigits value=“3”/> | | | |
| | </restriction> | | | |
| | </simpleType> | | | |
| SNVT_angle_deg | SNVT_angle_deg describes degree for phase and rotation. The type of | | | |
| | SNVT_angle_deg is snvt:angle_degType. | | | |
| | Phase/Rotation | | | |
| | SNVT Index | Measurement | Type Category | Type Size |
| | 104 | Angular distance | Signed Long | 2 bytes |
| | Valid Type Range | Type Resolution | Units | Invalid Value |
| | −359.98 . . . 360.00 | 0.02 | degrees | 32,767 (0x7FFF) |
| | Raw Range | Scale Factors | File Name | Default Value |
| | −17.999 . . . 18,000 | 2, −2, 0 | N/A | N/A |
| | (0xB9B1 . . . 0x4650) | S = a * 10^{b} * (R + c) | | |

The present application contains a subject matter related to U.S. Patent Application No. 61/081,358, filed in the United States Patent and Trademark Office on Jul. 16, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A method for representing sensory effects, comprising:
receiving sensory effect metadata including sensory effect information;
obtaining the sensory effect information by analyzing the sensory effect metadata; and
generating sensory device command metadata for controlling sensory devices corresponding to the sensory effect information,
wherein the sensory device command metadata includes sensory device command description information for controlling the sensory devices.

2. The method of claim 1, further comprising:
receiving sensory device capability metadata including capability information of the sensory devices,
wherein said generating sensory device command metadata further includes referring the capability information included in the sensory device capability metadata,

3. The method of claim 1, further comprising:
receiving user sensory preference metadata including preference information of a user about a predetermined effect,
wherein said generating sensory device command metadata further includes referring the preference information included in the user environment information.

4. The method of claim 1, further transmitting the sensory device command metadata to the sensory device.

5. The method of claim 1, wherein the sensory device command description information includes device command general information having information about On/Off switching states, positions, and directions of the sensory devices.

6. The method of claim 1, wherein the sensory device command description information includes device specific command information having specific operation commands of the sensory devices.

7. An apparatus for representing sensory effects, comprising:
an input unit configured to receive sensory effect metadata including sensory effect information about sensory effects applied to media; and
a control unit configured to obtain the sensory effect information by analyzing the sensory effect metadata and generate sensory device command metadata for controlling sensory devices corresponding to the sensory effect information,
wherein the sensory device control metadata includes sensory device command description information for controlling the sensory device.

8. The apparatus of claim 7, wherein the sensory device command description information includes information about On/Off switching states, positions, and directions of the sensory devices.

9. The apparatus of claim 7, wherein the sensory device command description information includes specific operation commands for the sensory devices.

10. A method for realizing sensory effects, comprising:
receiving sensory device command metadata for realizing sensory effects applied to media from an apparatus for representing sensory effects; and
realizing the sensory effects using the sensory device command metadata,
wherein the sensory device command metadata includes sensory device command description information for controlling the sensory devices.

11. The method of claim 10, further comprising:
transmitting sensory device capability metadata for generating the sensory device command metadata to the apparatus for representing sensory effects.

12. The method of claim 10, wherein the sensory device command description information includes device command general information having information about On/Off switching states, positions, and directions of the sensory devices.

13. The method of claim 10, wherein the sensory device command description information includes specific operation commands for the sensory devices.

14. An apparatus for realizing sensory effects, comprising:
an input unit configured to receive sensory device command metadata for realizing sensory effects applied to media from an apparatus for representing sensory effects; and
a controlling unit configured to realize the sensory effects using the sensory device command metadata,
wherein the sensory device command metadata includes sensory device command description information for controlling the sensory devices.

15. A computer readable recording medium storing metadata, wherein the metadata comprising:
Sensory device command metadata for controlling sensory devices corresponding sensory effect information,
wherein the sensory device command metadata includes sensory device command description information for controlling the sensory devices.
